(19) United States
(12) Patent Application Publication
(10) Pub. No.: US 2024/0044367 A1
(43) Pub. Date: Feb. 8, 2024

(54) CONTROL NODE FOR A MAGNETIC BEARING, ASSOCIATED SYSTEM AND METHOD

(71) Applicant: SKF Magnetic Mechatronics, Saint-Marcel (FR)

(72) Inventors: Olivier LEMARCHAND, Guichainville (FR); Sylvain Palmeri, Angerville la campagne (FR); Lakdar Sadi-Haddad, Nogent sur Marne (FR)

(21) Appl. No.: 18/357,373

(22) Filed: Jul. 24, 2023

(30) Foreign Application Priority Data
Aug. 2, 2022 (FR) 2208009

(51) Int. Cl. F16C 32/04; G06F 13/42

(52) U.S. Cl. CPC F16C 32/0451; G06F 13/4282; G06F 2213/0002

(57) ABSTRACT

A control node (3) for controlling a magnetic bearing is configured to control a servo axis of the bearing. The control node includes a synchronization module (15) configured to generate a synchronization signal (SYNC) upon receipt of synchronization information (INFO). At least one internal clock (17, 18) is configured to be synchronized with the synchronization signal (SYNC).

### CROSS-REFERENCE TO RELATED APPLICATION

This application claims priority to French Application No. 2208009, filed Aug. 2, 2022, the entirety of which is hereby incorporated by reference.

### FIELD

The present disclosure relates to the control of magnetic bearings.

The present disclosure more specifically relates to a control node for a magnetic bearing, a system for controlling a magnetic bearing comprising said nodes and a method for synchronizing said nodes.

### BACKGROUND

Conventionally, a system for controlling a magnetic bearing is based on a centralized architecture comprising a “master” position controller implementing an algorithm for controlling the magnetic bearing and “slave” amplifiers controlling power converters controlling various servo axes of the bearing, with the amplifiers themselves being controlled by the position controller.

Generally, the number of amplifiers is not specifically adapted to the number of servo axes of the bearing controlled by the control system, and is greater than the number of controlled servo axes.

This notably leads to an increase in the cost of the system.

Furthermore, in order to synchronize the controller and the amplifiers of the control system, a synchronization clock of the system transmits a generally rectangular analogue synchronization signal, at the sampling frequency of the system, to the controller and the amplifiers via a wire.

However, the computing power available to implement the control algorithm is limited by the size of the controller, notably limiting the number of servo axes of the magnetic bearing.

Furthermore, synchronization by the analogue synchronization signal is not reliable. If the wire is interrupted or if the synchronization signal is not received satisfactorily, elements are no longer synchronized.

In order to increase the computing power of the system for controlling a magnetic bearing, a distributed type of architecture can be implemented.

In this architecture, tasks performed by the controller are performed by the amplifiers in order to free up the computing power of the controller, for example, the amplifiers can control the power converters on the basis of data generated by sensors of the magnetic bearing, with the controller monitoring the amplifiers.

However, the data exchanges between the controller and the amplifiers needs to be synchronized in order to prevent a time lag in the data exchanged between each element that could disrupt the control of the system.

As described above, a synchronization clock of the system transmitting an analogue synchronization signal is implemented.

Furthermore, as each amplifier independently controls the power converter, and as the power switching of each power converter generates electromagnetic disruption that notably degrades the quality of the sampled data generated by the sensors, it is not possible to impose the switching times of all the amplifiers in order to improve the quality of the data.

Overcoming all or some of these disadvantages is therefore proposed.

### SUMMARY

In view of the above, the disclosure proposes a method for synchronizing at least two identical nodes for controlling a magnetic bearing connected by a two-way serial data bus, with each node controlling a different servo axis of the bearing.

“Servo axis of the bearing” is understood to mean the axis that is defined by two diametrically opposed coils of the stator of the magnetic bearing.

The method comprises:

generating synchronization information;

a synchronization module of each control node generating a synchronization signal upon receipt of the synchronization information;

synchronizing at least one internal clock of each node with the synchronization signal so that the control of all the axes by said nodes is synchronous.

The synchronization signal allows all the functions of the nodes for controlling the magnetic bearing to be synchronized so that the control of all the axes by said nodes is synchronous.

According to one feature, the method comprises:

clocking the two-way serial data bus using a master node formed by one of the two nodes, with the internal clock comprising a communication clock, the bus being clocked by the communication clock of the master node.

Preferably, the internal clock comprises a control clock, a power clock, a measurement clock, each node comprises a control module comprising the control clock, the power clock, the measurement clock, and a power converter connected to a set of coils of the servo axis, the method comprising synchronizing the control clock, the power clock and the measurement clock with the synchronization signal, controlling the power converter on the basis of data exchanged on the two-way serial data bus and of measurements taken by at least one sensor of the magnetic bearing, the control module being clocked by the control clock, the power converter and the sensor being clocked by the power clock and the measurement clock, respectively.

Advantageously, the frequencies of the control clock signal delivered by the control clock, of the power clock signal delivered by the power clock and of the measurement clock signal delivered by the measurement clock are each a multiple of the synchronization signal.

A node for controlling a magnetic bearing is also proposed that is configured to control a servo axis of the bearing, comprising:

a synchronization module configured to generate a synchronization signal upon receipt of synchronization information; and

at least one internal clock configured to be synchronized with the synchronization signal.

Preferably, the internal clock comprises a control clock, a measurement clock, and a power clock, the node further comprises a control module comprising the control clock, the power clock, and the measurement clock configured to be synchronized with the synchronization signal, and comprising a power converter configured to control a set of coils of the servo axis on the basis of data exchanged on a two-way serial data bus and of measurements taken by at least one sensor of the magnetic bearing, the control clock, the power clock, and the measurement clock being respectively configured to clock the control module, the converter, and the sensor.

Advantageously, the control node forms a master node, with the internal clock comprising a communication clock configured to clock the two-way serial data bus intended to connect said control node to another identical control node.

A control system for a magnetic bearing is also proposed comprising at least one servo axis comprising a set of coils, a sensor of the magnetic bearing, and at least a first control node as defined above and connected to a two-way serial data bus, the power converter of the control module being connected to the set of coils, and the sensor of the magnetic bearing being connected to the control module.

Advantageously, the control system comprises a second servo axis comprising a second set of coils, a second sensor of the magnetic bearing, and a second control node as defined above and connected to the two-way serial data bus, the power converter of the control module of the second node being connected to the second set of coils, and the second sensor of the magnetic bearing being connected to the control module of the second node. Preferably, the system further comprises a controller for controlling the position of the bearing generating the synchronization signal.

### BRIEF DESCRIPTION OF THE DRAWINGS

Further aims, features and advantages of the disclosure will become apparent upon reading the following description, which is provided solely by way of a non-limiting example, and with reference to the accompanying drawings, in which:

FIG. 1 illustrates an example of a system for controlling a magnetic bearing according to the disclosure;

FIG. 2 illustrates an example of a node for controlling a magnetic bearing according to the disclosure for an embedded system for controlling a magnetic bearing; and

FIG. 3 illustrates an example of control signals according to the disclosure.

### DETAILED DESCRIPTION

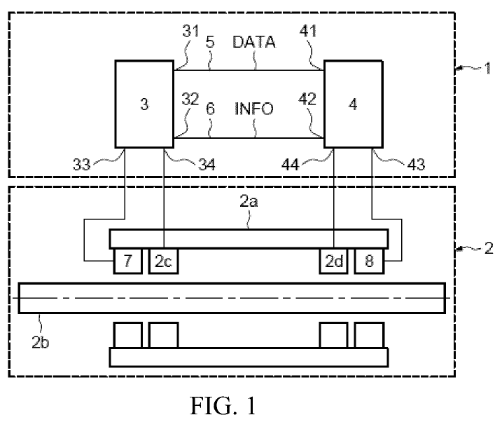

Reference is made to FIG. 1, which illustrates an example of a control system 1 for a magnetic bearing controlling a magnetic bearing 2.

In a manner per se known, the magnetic bearing 2 comprises a stator 2a and a rotor 2b placed in the stator 2a.

The stator 2a comprises two sets 2c, 2d of coils evenly distributed in the circumferential direction on the inner side of the stator 2a.

Each set 2c, 2d of coils comprises two diametrically opposed coils that are connected together so as to be simultaneously powered by an electrical power converter.

Two diametrically opposed stator coils define a servo axis of the magnetic bearing and allow this axis to be controlled.

The control system 1 comprises a first control node 3 and a second node 4.

The first node 3 comprises a first connection 31 connected by a two-way serial data bus 5 to a first connection 41 of the second control node 4.

A data bus 6 connects a second connection 32 of the first node 3 to a second connection 42 of the second node 4.

The data bus 5 transmits data DATA for controlling the bearing 2 that is transmitted and received by the nodes 4, 5.

The data bus 6 transmits synchronization information INFO to the nodes 4, 5, with the transmission of two successive items of synchronization information INFO being separated by a predefined duration.

Each node 4, 5 controls a different servo axis of the magnetic bearing 2, so that the control system 1 controls two servo axes of the magnetic bearing 2.

To this end, the first node 3 comprises a control output 34 connected to a first set 2c of coils, and the second node 4 comprises a control output 44 connected to the second set 2d of coils.

Of course, the system 1 can comprise more than two control nodes for controlling more than two servo axes of the magnetic bearing 2. An additional control node simply needs to be added for each controlled servo axis, with the additional node being connected in series to an adjacent node by means of the bus.

The modular structure of the control system 1 allows the number of control nodes to be implemented that corresponds to the number of controlled servo axes.

The magnetic bearing 2 comprises a first sensor 7 connected to a first input 33 of the first node 3, a second sensor 8 connected to a first input 43 of the second node 4.

The sensors 7, 8 measure, for example, radial or axial displacements of the rotor 2b, and generally include an analogue-to-digital converter 11 so that the nodes 3, 4 receive digital measurement data.

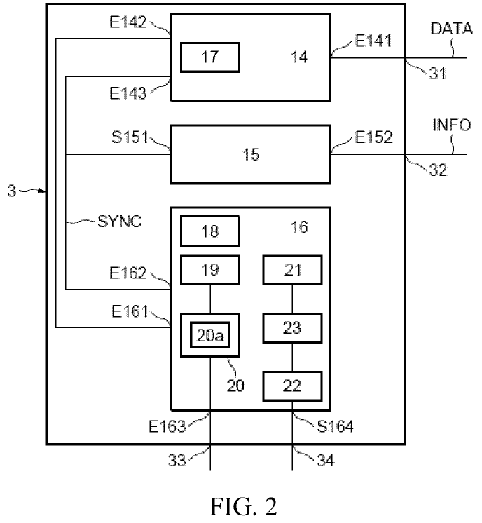

As the nodes 3, 4 are identical, only one example of the architecture of the first node 3 will now be described in FIG. 2.

The control node 3 comprises a communication module 14, a synchronization module 15 and a control module 16.

The communication module 14 comprises a first input E141 connected to the first connection 31 of the node 3, a second input E142 connected to a first input E161 of the control module 16, and a third input E143 connected to an output S151 of the synchronization module 15.

The communication module 14 further comprises a communication clock 17 clocking the bus 5 when the node forms a master node.

The synchronization module 15 further comprises a first input E152 connected to the second connection 32 of the node 3.

The control module 16 further comprises a second input E162 connected to the output S151 of the synchronization module 15, a third input E163 connected to the first input 33, and an output S164 connected to the first output 34.

The control module 16 comprises a control clock 18.

The control module 16 further comprises a measurement clock 19, measurement means 20 connected to the third input E163 and clocked by the measurement clock 19, a power clock 21, a power converter 22, and control means 23 for controlling the power converter 22 clocked by the power clock 21.

An output of the power converter 22 is connected to the output S164 so that the power converter 22 powers the first set 2c of coils of a first servo axis of the magnetic bearing.

The measurement means 20 comprise an analogue-to-digital converter 20a.

The communication module 14 exchanges the data DATA with the bus 5 and the second node 4.

The synchronization module 15 receives the synchronization information INFO via the bus 6.

Upon receipt of the synchronization information INFO circulating on the bus 6, the module 15 generates a synchronization signal SYNC so that at least one internal clock of all the nodes 3, 4 is synchronized with the synchronization signal SYNC allowing synchronous control of all the axes by said nodes.

The synchronization information INFO ensures the synchronization of all the control nodes.

The synchronization info, established between the synchronization modules of nodes 3 and 4, is native to the intrinsic communication protocol of bus 6. Periodic exchanges on bus 6 are the source of the synchronization info.

The synchronization signal SYNC is transmitted to the communication 14 and control 16 modules so as to at least synchronize the internal clock comprising the communication clock 17, the control clock 18, the measurement clock 19 and the power clock 21, with the synchronization signal SYNC, with the communication clock 17 being synchronized with the signal SYNC when the node 3 forms the master node.

Following synchronization with the synchronization signal SYNC, the control clock 18 delivers a control clock signal RTPULCK, the measurement clock 19 delivers a measurement clock signal ADCLK, and the power clock 21 delivers a power clock signal PWMCLK.

The control means 23 control the power converter 22 on the basis of the measurements of the first sensor 7 and of the data DATA received by the communication module 14.

The power converter 22 is, for example, controlled by the control means 23 by Pulse Width Modulation (PWM).

The frequencies of the control clock signal RTPULCK clocking the control module 16, of the power clock signal PWMCLK clocking the first power converter 9 and of the measurement clock signal ADCLK clocking the analogue-to-digital converter 20a are each equal to a multiple of the synchronization signal SYNC so that the communication modules 14 and the control module 16 of all the nodes are synchronized.

The frequencies of the signals SYNC, PWMCLK and ADCLK can be equal.

Furthermore, as the frequencies of the signals PWMCLK and ADCLK are synchronized to the frequency of the synchronization signal SYNC, the multiples of the frequencies of the signals PWMCLK and ADCLK can be selected so that the analogue-to-digital conversion of the measurement results by the analogue-to-digital converter 20a do not coincide with the switching times of the power converters of the first and second nodes 3, 4 in order to make the digital measurement values transmitted by the sensors 7, 8 reliable.

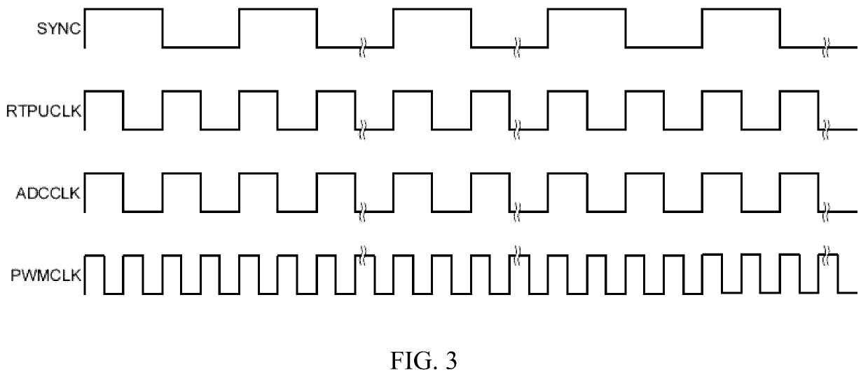

FIG. 3 shows an example of the synchronization SYNC, control clock RTPULCK, measurement clock ADCLK and power clock PWMCLK signals.

What is claimed is:

1. A method for synchronizing at least two identical nodes for controlling a magnetic bearing connected by a two-way serial data bus, with each node controlling at least one different servo axis of the magnetic bearing, the method comprising:
generating synchronization information;
a synchronization module of each control node generating a synchronization signal upon receipt of the synchronization information;
synchronizing at least one internal clock of each node with the synchronization signal so that the control of all the axes by said nodes is synchronous.

2. The method according to claim 1, further comprising:
clocking the two-way serial data bus using a master node formed by one of the two nodes, with the internal clock comprising a communication clock, the bus being clocked by the communication clock of the master node.

3. The method according to claim 1, wherein the internal clock comprises a control clock, a power clock, a measurement clock, each node comprises a control module comprising the control clock, the power clock, the measurement clock, and a power converter connected to a set of coils of the servo axis, the method comprising synchronizing the control clock, the power clock and the measurement clock with the synchronization signal, controlling the power converter on the basis of data exchanged on the two-way serial data bus and of measurements taken by at least one sensor of the magnetic bearing, the control module being clocked by the control clock, the power converter and the sensor being clocked by the power clock and the measurement clock, respectively.

4. The method according to claim 3, wherein the frequencies of the control clock signal delivered by the control clock, of the power clock signal delivered by the power clock and of the measurement clock signal delivered by the measurement clock are each a multiple of the synchronization signal.

5. The method according to claim 2, wherein the internal clock comprises a control clock, a power clock, a measurement clock, each node comprises a control module comprising the control clock, the power clock, the measurement clock, and a power converter connected to a set of coils of the servo axis, the method comprising synchronizing the control clock, the power clock and the measurement clock with the synchronization signal, controlling the power converter on the basis of data exchanged on the two-way serial data bus and of measurements taken by at least one sensor of the magnetic bearing, the control module being clocked by the control clock, the power converter and the sensor being clocked by the power clock and the measurement clock, respectively.

6. The method according to claim 5, wherein the frequencies of the control clock signal delivered by the control clock, of the power clock signal delivered by the power clock and of the measurement clock signal delivered by the measurement clock are each a multiple of the synchronization signal

7. A control node for controlling a magnetic bearing configured to control a servo axis of the bearing, the control node comprising:
a synchronization module configured to generate a synchronization signal upon receipt of synchronization information; and
at least one internal clock configured to be synchronized with the synchronization signal.

8. The control node according to claim 7, wherein the internal clock comprises a control clock, a measurement clock, and a power clock, the node further comprising a control module comprising the control clock, the power clock, and the measurement clock configured to be synchronized with the synchronization signal, and comprising a power converter configured to control a set of coils of the servo axis on the basis of data exchanged on a two-way serial data bus and of measurements taken by at least one sensor of the magnetic bearing, the control clock, the power clock, and the measurement clock being respectively configured to clock the control module, the converter, and the sensor.

9. The control node according to claim 8, forming a master node, with the internal clock comprising a communication clock configured to clock the two-way serial data bus intended to connect said control node to another identical control node.

10. A control system for a magnetic bearing comprising at least one servo axis comprising a set of coils, a sensor of the magnetic bearing, and at least a first control node according to claim 8 connected to a two-way serial data bus, the power converter of the control module being connected to the set of coils, and the sensor of the magnetic bearing being connected to the control module.

11. The control system for a magnetic bearing according to claim 10, comprising a second servo axis comprising a second set of coils, a second sensor of the magnetic bearing, and a second control node according to claim 8 connected to the two-way serial data bus, the power converter of the control module of the second node being connected to the second set of coils, and the second sensor of the magnetic bearing being connected to the control module of the second node.

12. A control system for a magnetic bearing comprising at least one servo axis comprising a set of coils, a sensor of the magnetic bearing, and at least a first control node according to claim 9 connected to a two-way serial data bus, the power converter of the control module being connected to the set of coils, and the sensor of the magnetic bearing being connected to the control module.

13. The control system for a magnetic bearing according to claim 12, comprising a second servo axis comprising a second set of coils, a second sensor of the magnetic bearing, and a second control node according to claim 8 connected to the two-way serial data bus, the power converter of the control module of the second node being connected to the second set of coils, and the second sensor of the magnetic bearing being connected to the control module of the second node.
